(19) United States
(12) Patent Application Publication
(10) Pub. No.: US 2010/0014699 A1
(43) Pub. Date: Jan. 21, 2010

(54) REVERSIBLE HEADSET

(76) Inventors: John F. Anderson, Hopkins, MN (US); Niels T. Andersen, Lakeville, MN (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 12/487,421

(22) Filed: Jun. 18, 2009

Related U.S. Application Data
(60) Provisional application No. 61/073,583, filed on Jun. 18, 2008.

(51) Int. Cl. H04R 25/00

(52) U.S. Cl. 381/375

(57) ABSTRACT

The reversible headset includes a curved body, at least one connection point and an ear hanger. The curved body includes a first end and a second end. The curved body is configured to be worn around the nape of the wearer's neck. The at least one connection point is suitable for connection of a hands-free communication device. The ear hanger extends from each of the first and second ends. The ear hanger includes an end portion and a body portion. The end portion is configurable to terminate at the top, forward portion of the pinna of a wearer's ear. The body portion is configurable to extend around the outer periphery of the pinna.

### CROSS-REFERENCE TO RELATED APPLICATIONS

This Utility Patent Application claims priority to U.S. Provisional Patent Application No. 61/073,583 filed on Jun. 18, 2008, which is incorporated herein by reference.

### BACKGROUND

In many situations, use of a hands free communication device is desired. These devices typically are in the form of over-the-head bands, behind-the-head bands, or single ear hooks. The devices usually require adjustments by each user at each use. The over-the-head band styled headsets collide with hair styles and do not allow the wearer to use in conjunction with glasses, goggles, helmets, or hat. Single ear-hook headsets are typically formed to hang on the outer periphery of one ear and include a microphone arm to allow it to be adjusted to work in either the left or right ear. Single ear-hook headsets are often unstable and are difficult to adjust and place the microphone in proper position. The microphone arm requires adjustment with each wear and may easily become dislodged from the wearer's ear.

For these and other reasons, there is a need for the present invention.

### SUMMARY

One embodiment provides for a reversible headset including a curved body having a first end and a second end. The curved body is configured to be worn around the nape of the wearer's neck. At least one connection point is suitable for connection of a hands-free communication device, at least one connection point for an earphone, and an ear hanger extending from each of the first and second ends. The ear hanger includes an end portion and a body portion. The end portion is configurable to terminate at the top, forward portion of the pinna of a wearer's ear. The body portion is configurable to extend around the outer periphery of the pinna.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1A illustrates one embodiment of a reversible headset.

FIG. 1B illustrates one embodiment of a reversible headset.

FIG. 2 illustrates one embodiment of a reversible headset with a microphone boom.

FIG. 3 illustrates one embodiment of a reversible headset with microphone boom and earphones attached.

FIG. 4 illustrates one embodiment of a reversible headset with microphone.

FIG. 5 illustrates one embodiment of a connection point on the reversible headset.

FIG. 6 illustrates one embodiment of a reversible headset connection of an ear hanger and microphone boom.

FIG. 7 illustrates another embodiment of a reversible headset.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Embodiments provide a reversible headset configured for improved user wearability. The rotatable ear hangers allow the wearer to reverse the orientation of a microphone to opposite sides of the wearer's head (e.g. left to right). Embodiments provide rotatable ear hangers. Embodiments provide for a headset having a low profile design which can be worn with a hat and glasses. Embodiments are configured for attachment to both ears of the wearer.

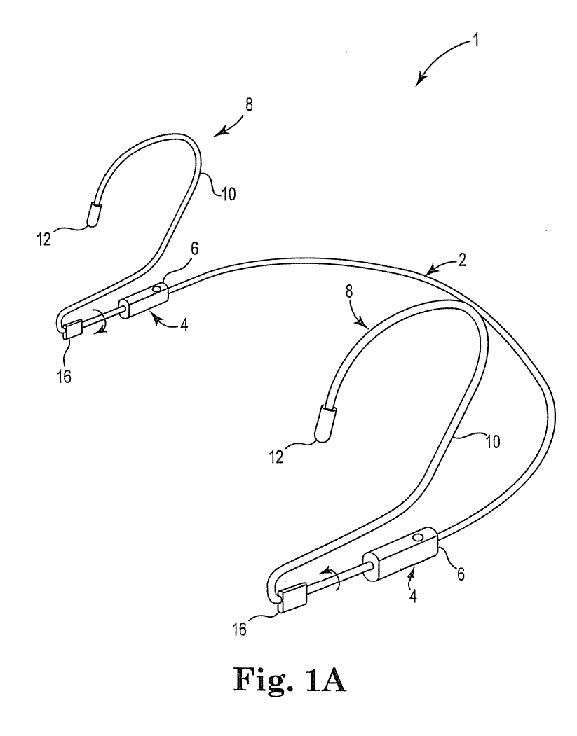

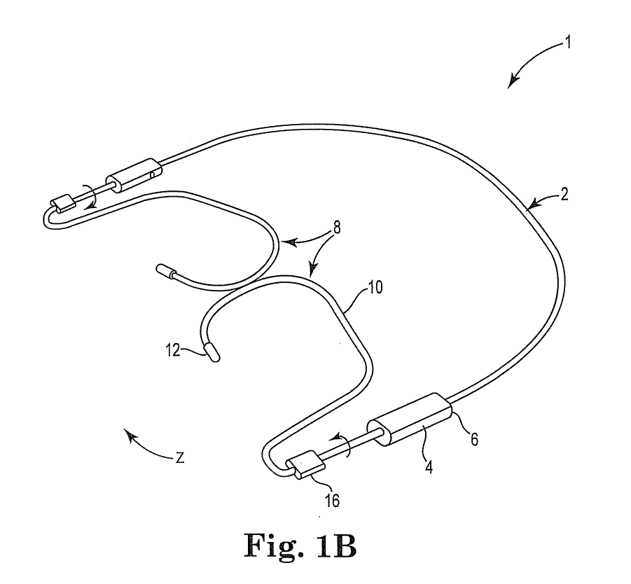

FIG. 1A illustrates one embodiment of a reversible headset 1. Headset 1 includes body 2. In one embodiment, body 2 is curved in a semi-eliptical or semi-circular shape. In one embodiment, connection points 4 are configured at each end 8. In one embodiment, body 2 is constructed of a lightweight plastic, metal, or other suitable material. In one embodiment, body 2 is constructed of a flexible material, suitable for bending in multiple directions. In one embodiment, body 2 is constructed of a material suitable for bending and maintaining a desired shape.

In one embodiment, ear hangers 8 are rounded and include main portion 10 and end portions 12. In one embodiment, ear hangers 8 are asymmetrical. In one embodiment, ear hangers 8 are constructed of a lightweight plastic, metal, or other suitable material. In one embodiment, end portions 12 are constructed of a material which is softer than the body portion of ear hangers 8, such as rubber. In one embodiment, connection point 4 is configured to provide attachment of a hands-free communication device such as a microphone or ear phone or other communication device. In one embodiment, at least one wire holder 16 is provided on headset 1. In one embodiment, wires for the communication equipment will extend out the back of connection 4 and outside ear hangers 8 and removable secured to body 2 with wire holders 16, to reduce interference with the rotation of ear hangers 8.

FIG. 1B illustrates one embodiment of reversible headset 1 with rotatable ear hangers 8. In one embodiment, ear hangers 8 are rotatable at connection points 4. In one embodiment, ear hangers 8 may be rotated in order to be in the same plane as body 2 of headset 1, thereby providing for ease of packing or storing. In one embodiment, ear hangers 8 may be rotated 180° at connection point 4, thereby reversing the orientation of an attached microphone boom on the opposite side of the wearer's head (e.g. left to right side) without removal or adjustment of the microphone. In one embodiment, ear hangers 8 are rotated toward the inner curvature of body 2.

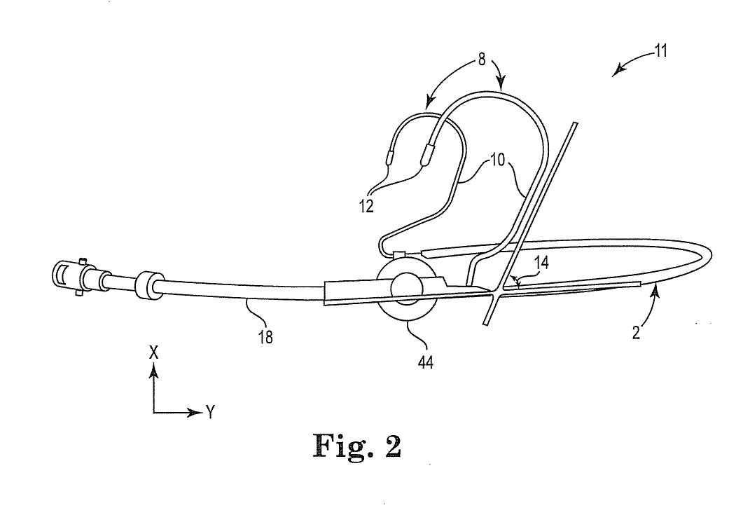

FIG. 2 illustrates one embodiment of reversible headset 11. In one embodiment, headset 11 includes ear hangers 8 configured at an angle 14 with respect to body 2. In one embodiment, angle 14 is an acute angle. In one embodiment, microphone boom 18 is angled appropriately toward the mouth of the wearer, eliminating the need for further adjustment of microphone boom 18. In this embodiment, the microphone boom 18 is an arm cantilevered in such a manner that it can be positioned in the space near the front or side of the mouth, as desired for audio performance and noise cancellation. In one embodiment, a flexible microphone boom 18 is constructed of a flexible, yet semi-rigid, material that maintains a desired position upon adjustment. In one embodiment, body 2 and microphone boom 18 are configured to position lower than the top of the user's ears when worn.

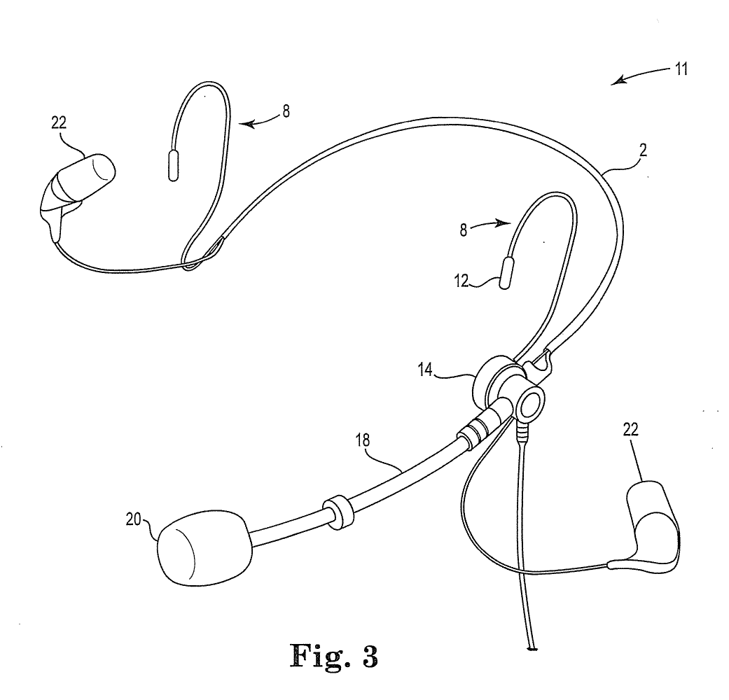

FIG. 3 illustrates one embodiment of reversible headset 11 with microphone boom 18 and at least one ear piece 22 attached. In one embodiment, at least one ear piece 22 is connected for use in a single ear or both ears, as applicable to the noise application in the environment and for comfort of the wearer. In one embodiment, connection points 14 provide for mechanical and electrical connection of microphone boom 18 and ear piece 22.

In one embodiment, ear hangers 8 are rotatable with respect to body 2 of headset 1. In one embodiment, connection points 14 allow the device to have microphone boom 18 mounted on either the right or left side. In one embodiment, ear hangers 8 are formed in a shape comfortable to the outer periphery of the pinna. In one embodiment, microphone boom 18, and ear piece 22 and ear hangers 8 are constructed and arranged to be adjustable and comfortable of a wearer. In one embodiment, headset 11 is configured with removable connections to microphone boom 18 and ear piece 22. In one embodiment, ear hangers 8 include a rotatable hinge which is biased into a predetermined position. In one embodiment, ear hangers 18 extend forward on the top side of the ear when in wearable position.

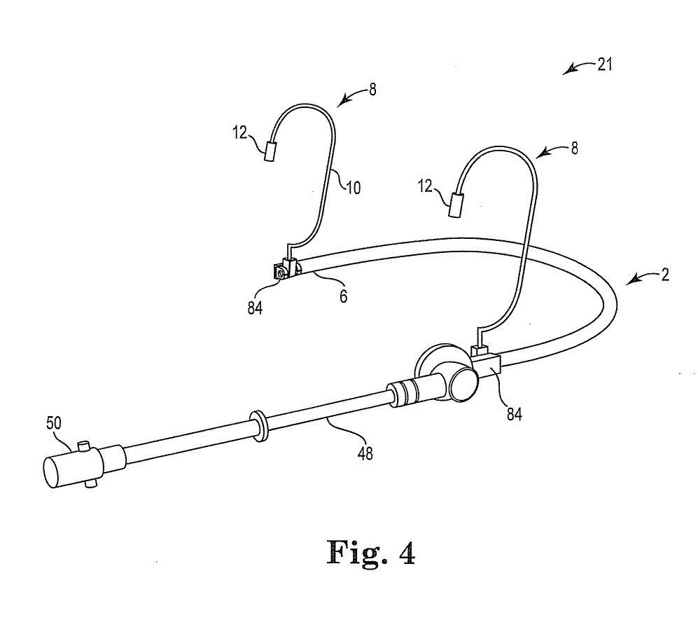

FIG. 4 illustrates one embodiment of reversible headset 21 with microphone 50. In one embodiment, microphone 50 may be a boom microphone or other suitable communication device. In one embodiment, microphone 50 is a high quality noise canceling microphone which provides clear communication in high noise environments and extend from microphone boom 48. In one embodiment, body 2 and microphone boom 18 attach at opposite sides of connection 84. In another embodiment, microphone 50 is a cell phone, a two-way radio or other device.

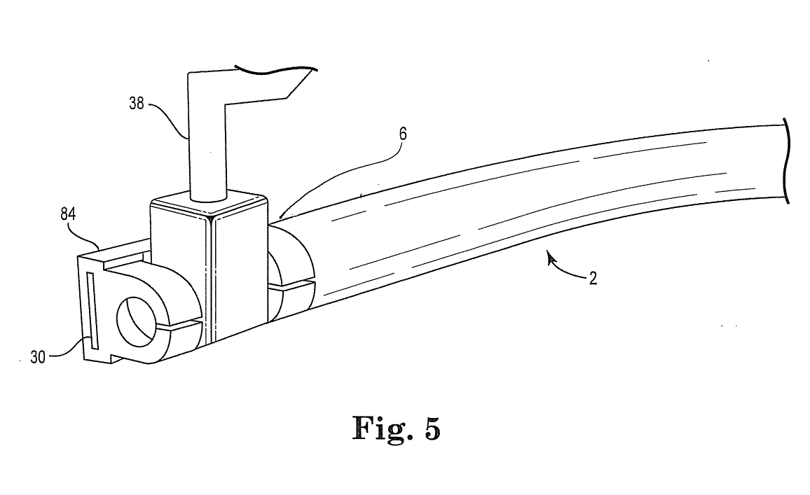

FIG. 5 illustrates one embodiment of connection point 4 on headset 1. In one embodiment, connection points 84 are positioned at the first and second ends 6 of body 2. In one embodiment, connection point 84 provides for mechanical connection of reversible ear hangers 38. In one embodiment, connection point 84 provides for electrical and mechanical connection of microphone boom 48, ear piece 22, or other communication device.

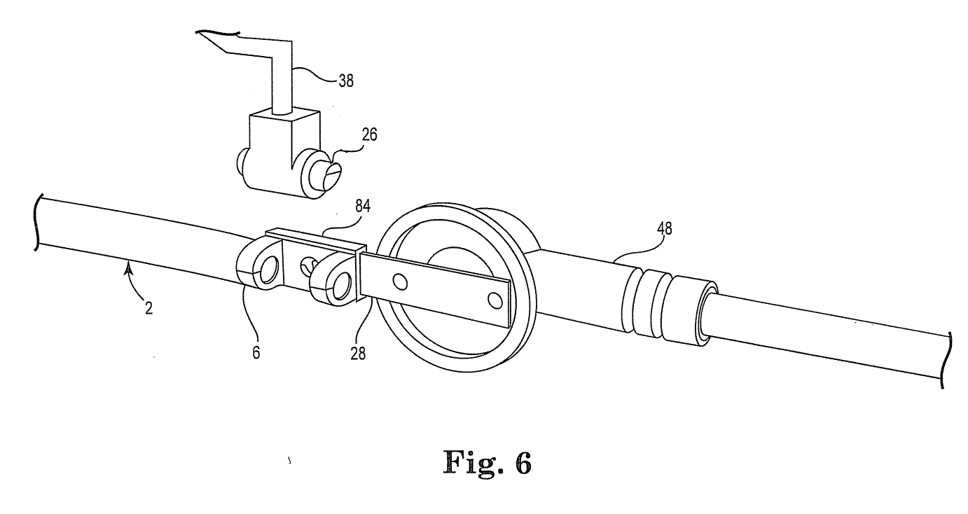

FIG. 6 illustrates one embodiment of connection point 84 on headset 21. In one embodiment, removable connection of ear hangers 38 is provided. In one embodiment, ear hangers 38 include nodules 26 for mechanical connection at connection point 84. In one embodiment, the microphone boom 48 or other communication device may have slidable connection tab 28. In one embodiment, connection tab 28 slides into slot 30 of connection point 84.

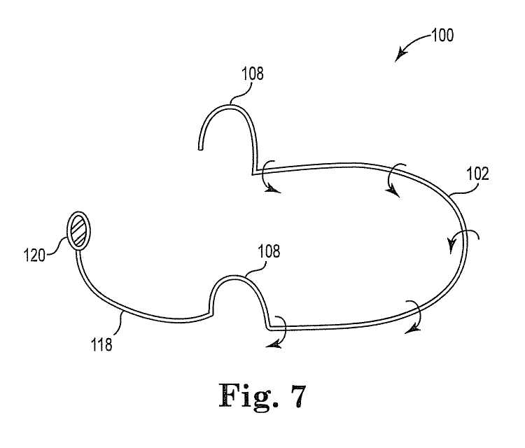

FIG. 7 illustrates one embodiment of reversible headset 100. In one embodiment, microphone boom 118 is configured to extend from end portion 112 of ear hangers 108. In one embodiment, reversible headset 100 is rotatable or twistable, along body 102 to provide reorientation of microphone boom 118. In one embodiment, microphone boom 118 is connected at end portion 112 of ear hanger 108. In one embodiment, body 102, ear hangers 108 and microphone boom 118 are constructed of the same material, such as a bendable plastic or metal, for example. In one embodiment the bendable material is tubular.

It is to be understood that the features of the various exemplary embodiments described herein may be combined with each other, unless specifically noted otherwise.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A reversible headset comprising:
a curved body including a first end and a second end, wherein the curved body is configured to be worn around the nape of the wearer's neck;
at least one connection point suitable for connection of a hands-free communication device; and
an ear hanger extending from each of the first and second ends, wherein the ear hanger includes an end portion and a body portion, the end portion configurable to terminate at the top, forward portion of the pinna of a wearer's ear, and the body portion being configurable to extend around the outer periphery of the pinna.

2. The reversible headset of claim 1, wherein the ear hangers are rotatable about an axis of the curved body of the headset.

3. The reversible headset of claim 2, wherein the ear hangers are rotatable to be in the same plane as the curved body of the headset.

4. The reversible headset of claim 1, additionally comprising at least one wire holder.

5. The reversible headset of claim 1, wherein the at least one connection point includes mechanical and electrical connection.

6. The reversible headset of claim 1, comprising at least one connection point for an earphone.

7. The reversible headset of claim 1, wherein the body is comprised of a lightweight plastic or metal material.

8. The reversible headset of claim 1, wherein the ear hangers are comprised of a lightweight plastic or metal material.

9. The reversible headset of claim 1, wherein the headset is comprised on a flexible material.

10. The reversible headset of claim 1, additionally comprising the microphone connected to the curved body at the connection point.

11. The reversible headset of claim 1, wherein the ear hangers are detachable.

12. The reversible headset of claim 1, wherein an angle of the ear hanger is acute with respect to the curved body when positioned to be worn.

13. The reversible headset of claim 1, wherein the connection point is at the end portion of the ear hanger.

14. The reversible headset of claim 1, wherein the connection point is at the first or second end of the curved body.

15. A headset support comprising:
a curved body including a first end and a second end;
at least one connection point adaptable for connection to a cell phone, a 2-way radio, or other telephonic or communication device; and
two ear hangers extending from the fist and second ends, wherein each ear hanger includes an end portion and a body portion, the end portion configured to terminate at the top, forward portion of the pinna of a wearer's ear, and the body portion being configured to extend around the outer periphery of the pinna when worn.

16. The headset support of claim 15, wherein the ear hangers are rotatable about the axis of the curved body of the headset.

17. The headset support of claim 15, wherein the curved body is configured to be worn around the nape of the wearer's neck.

18. The headset support of claim 15, wherein the angle of the ear hanger is acute with respect to the curved body of the headset.

19. A reversible headset support, wearable on both ears of user, comprising:
a curved body extending from behind a first ear, wrap around the back of the user's head, terminating behind a second ear;
an ear hanger extending from each end of the curved body, the ear hangers each having an end portion terminating forward of the ear and a body portion located behind the pinna at the back of the ear;
a pivotal connection, wherein the body is connectable to the ear hangers; and
a connection point for communication devices.

20. A reversible headset comprising:
a headset support including a curved body positionable at the nape of the neck and two ear hangers positionable on top of the ear and extending to the back of the ear behind the pinna for connection to the curved body;
a means for rotating the ear hangers with respect to the curved body;
a microphone boom; and
at least one earphone.
